(19) United States
(12) Patent Application Publication
(10) Pub. No.: US 2003/0188508 A1
(43) Pub. Date: Oct. 9, 2003

(54) Self-supporting wooden structural panel

(76) Inventor: Jean-Luc Sandoz, Morges (CH)

Correspondence Address: Sanford E Warren Jr, Warren & Kennedy, Suite 910, 6565 MacArthur Blvd, Irving, TX, 75039-2461, US

(21) Appl. No.: 10/380,500

(22) PCT Filed: Sep. 5, 2001
(86) PCT No.: PCT/FR01/02750

(30) Foreign Application Priority Data
Sep. 14, 2000 (FR) 00/11698

(51) Int. Cl. E04C 2/00; E04C 2/54; E04B 9/00; E06B 3/54

(52) U.S. Cl. 52/782.1; 52/474

(57) ABSTRACT

The invention concerns a self-supporting wooden structural panel, useful for making walls as well as floors, ceilings or roofs, comprising a succession of boards (2a, 2b) rectangular in cross-section, assembled together forming a V-shaped structure. The invention is characterised in that the boards (2a, 2b) are mounted on two parallel racks (3) and are fixed via screws (4) on the crests of said racks which constitute rigid elements perpendicular to the axis of the boards (2a, 2b); two consecutive boards (2a, 2b) are assembled by screwing between the edge (6) of one board (2a) against the end of the flat side (5) of the consecutive board (2b); the two racks (3) perpendicular to the axis of the boards form a template for positioning them, preferably at 90° relative to each other.

### TECHNICAL FIELD

The present invention relates to the field of building and more especially to that of buildings.

It relates more particularly to a novel type of prefabricated panel or sheet, that can be used as covering or wall panel material for facades, for example for industrial buildings.

### PRIOR ART

In the building field, the production of prefabricated panels that can be used as covering material or material for cladding facades has been proposed for a very long time.

One of these solutions proposes the production, as is apparent from Figure A, of a range of self-supporting panels known as “sheeting” which may be between 1 and 8 meters long and which are obtained from thin sheet profiles to provide rigidity by increasing the static height.

Referring to this Figure A, which illustrates the profile of such sheeting, regardless of the material used, the structural performance, or bearing capability, is a direct function of the height of this rib. In this embodiment, it is possible to have a span of 6 meters using a steel sheet only a few tenths of a millimeter thick, but with a rib or profile of a height (H) of 7 centimeters.

Such profiled metal sheeting has undergone a great deal of development, but does, however, have disadvantages.

First of all, its cost is relatively high because of the paintwork needed to protect it. Its fire resistance is also very low and it is unable to be used as elements for stabilizing buildings. In addition, this type of panel generates very poor acoustics, both in terms of airborne noise (echoes) and in terms of noise transmitted through solid (the beating of rain), and has very poor thermal insulation against hot and cold.

It has also been proposed that wooden panels be produced in order to solve these problems of acoustics and thermal insulation.

Among the older solutions, mention may be made of those covered by French Patent FR-A-648 575 and, more recently, European Patent EP-A-0 203 868.

In general, the former of these documents, of which the attached Figure B is a reproduction of one embodiment it describes, relates to panels that can be used more particularly for producing a ceiling but which can also be used for vertical walls, and which consist of a succession of planks arranged in a V. These planks are machined on the edge to give a vertical bearing flat and a horizontal bearing flat. In order for such an element to work as a beam element, the joint is reinforced by various solutions, namely:

either a flat bar along the entire length;

or a piece of wood in the form of a triangular cross piece along the entire length;

or pieces of wood with alternating teeth forming a longitudinal battlement structure and offering surfaces for nailing on the V-configured planks, the teeth blocking shear forces.

These connecting elements are continuous and, as a result, such a solution has a high cost. In addition, machining the edges of the planks is not conceivable in the case of thin planks, for example between 20 and 30 millimeters thick, as such machining could weaken said planks or even break them.

A comparable solution is covered by the aforesaid European Patent, the constituent parts of which are assembled by adhesive bonding. In that document, the assembly consists of a panel with a flat surface, produced from planks or an equivalent material, which panel is strengthened to obtain greater rigidity by a structural box section of V shape, produced by adhesive bonding under said flat panel.

This system makes it possible to obtain self-supporting finished floors with a visible structure in the volume below alternating between Vs and flats. This type of building element is advantageous as a primary structure, for spans of 8 to 15 meters, and may be used as a secondary covering element, but is far too expensive in its design, especially for industrial buildings.

### BRIEF DESCRIPTION OF THE INVENTION

There has been found, and this is what forms the subject of the present invention, a novel type of self-supporting wooden building panel that can be used just as easily for producing walls as it can for floors, ceilings or coverings, and which comprise, in a similar way to the teachings of French Patent FR 648 575 a succession of planks of rectangular cross section, joined together to form a V structure, said panel being characterized in that:

the planks are mounted on two parallel racks and are fixed by screws to the crests of said racks which constitute rigid elements perpendicular to the axis of the planks;

two consecutive planks are joined together by screwing the edge of one plank against the end of the flat of the consecutive plank;

the two racks perpendicular to the axis of the planks form a template for positioning them, preferably at 90° with respect to the next one.

It could, however, be conceived of for the planks to be combined causing this angle to vary between 80° and 100° according to the desired mechanical performance. Thus, for the same size of plank, a smaller angle increases the performance by increasing the static height of the panel, and a larger angle reduces it, but saves on material.

By way of planks involved in producing a panel according to the invention, use will be made, for the planks assembled in a V configuration, of planks made of solid wood, reconstituted wood or glulam wood, of a rectangular section with a thickness of between 20 and 30 millimeters, assembled using small-diameter (3.5 to 4.5 millimeter) screws.

As for the racks, these will be cut to exhibit housings from resinous timber planks of the order of 40 millimeters thick.

The rack can be obtained by cutting a solid plank, but may also be produced from a panel of the MDF (medium density fiberboard) or laminated veneer lumber type or alternatively from any other natural or synthetic material that allows the planks to be screwed on. The number of racks is calculated according to the loads to be borne and the inertia of the panel, the inertia being given by its height (h) and the type of plank, and more particularly their cross section (thickness and width).

In the most general case, the two racks may be spaced between 3 and 8 meters apart, it being understood that with thinner planks, that is to say planks less than 27 millimeters thick, the number of racks will be higher whereas with thicker planks it will be possible to obtain a wider spacing.

Furthermore, the racks are preferably made of a material that is more dense than the planks, so that the screws used for securing said planks cannot pull out under the action of the suction on the roofing by the wind.

The racks which support the planks therefore act as ribs perpendicular to said planks, giving the panels a performance in both directions, longitudinal and transverse. The rack allows attachment by screwing to the primary structure, either onto a truss as a roofing panel or onto a post as a facade panel. The number of screws used to secure the planks is calculated according to the shear forces of the panel, which needs to react the horizontal forces due to the wind.

In consequence, the panel according to the invention now has just two structural elements, namely the thin planks assembled in a V configuration, and the rack. It is the thickness of the panel (h=static height of the panel) which dictates its mechanical performance.

It is the rack that allows forces to be transmitted between the panel and the primary bearing system, and which therefore allows the panel to act as a sheet.

In consequence, the rack plays an essential spreading part in distributing the forces to the bearing structure and improves the performance of the overall construction.

### BRIEF DESCRIPTION OF THE DRAWING

The invention and the advantages it has will be better understood from the description which follows, illustrated by the appended diagrams, in which:

Figures A and B illustrate, as mentioned previously, the state of the prior art.

FIG. 1 is a schematic perspective overall view of a panel produced according to the invention, FIG. 1 being an enlarged view of the encircled region of said figure;

FIGS. 2 and 3 illustrate two alternative forms of embodiment of a panel according to the invention;

FIGS. 4 and 5 are schematic perspective views showing the use of such panels to produce coverings and facades of a building;

FIG. 6 illustrates, viewed end-on, a panel according to the invention associated with a sealing and insulating complex;

FIG. 7 is an end-on view of a panel according to the invention incorporated as a facade wall; and

FIG. 8 is a panel according to the invention strengthened with concrete in the upper part in the compression region.

### EMBODIMENTS OF THE INVENTION

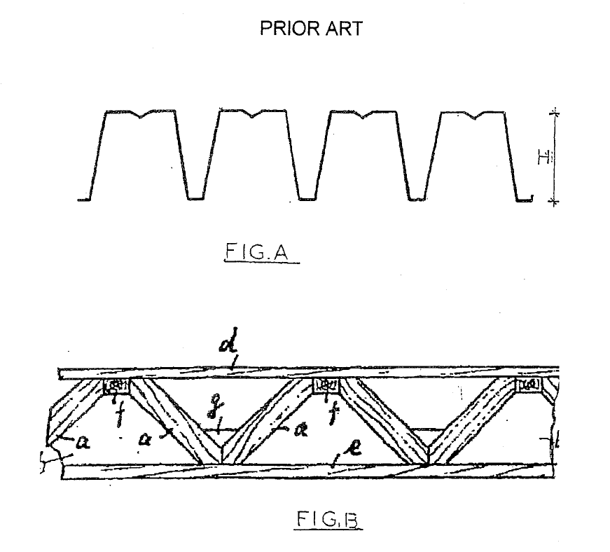

FIG. 1 illustrates the overall structure of a panel produced according to the invention.

In general, such a panel denoted by the reference (1) is made up of planks (2a, 2b) of rectangular cross section namely, in this instance, 27 millimeters thick and 200 millimeters wide.

These planks (2a, 2b) are mounted on two racks denoted by the same reference (3), made of wood and previously cut from planks of resinous timber about 40 millimeters thick.

These dimensions are indicative and allow the production of a self-supporting panel for a load of snow weighing 60 to 80 kg/M² and for a free span of 6 meters in the lengthwise direction, said racks being spaced a distance of the order of 3 to 8 meters apart.

The planks are rough sawn dried timber with the final water content that they will have in the building. This prior drying is important because it makes it possible to avoid dimensional variations such as shrinkage which would cause gaps to open up at the joints.

The planks are joined together by screws denoted by the same reference (4), only some of which are depicted in FIG. 1, and this is done making sure, as can be seen from this FIG. 1 and from FIG. 1a, that the screwing is carried out in such a way that the end (5) of the flat of the plank (2b) rests against the edge (6) of the next plank. A gasket may be interposed in the bearing region. The density of screws (4) is calculated according to the shear stresses to be reacted.

According to the invention, the planks (2a, 2b) are screwed to the crests (7) of the racks (3) using screws (8). These racks (3), which are about 40 millimeters thick, are preferably made of a material which is more dense than the planks (2a, 2b), for example of hardwood, laminated veneer lumber or MDF, so that the fixing screws (8) cannot pull out under the sucking action by the wind on the roof.

While in the example illustrated in FIG. 1 the planks (2a, 2b) make an angle of 90° between them, it may be conceivable to have a slightly smaller or slightly larger angle, varying between 80 and 100°, depending on the desired mechanical performance.

The rigidity or mechanical performance of the structure according to the invention is dictated by the height (h) of the assembly of planks (2a, 2b). Using wider planks or planks at a smaller angle, less than 90°, the performance of the panel increases by increasing the static height (h). However, the angle of 90° is more practical, particularly for mounting the planks one against the other.

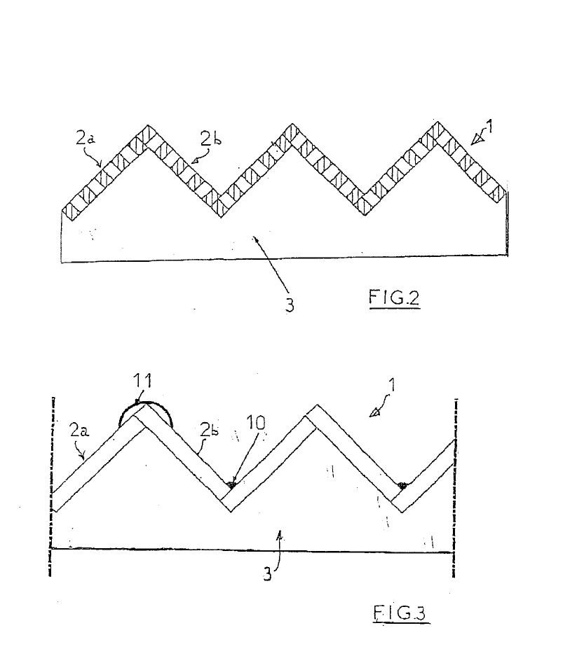

The rack (3) allows the panel according to the invention to be fixed by screws to the primary structure, either to a truss as a roofing panel or to a post as a facade panel, as can be seen from FIGS. 4 and 5.

The number of plank-connecting screws is calculated according to the shear forces of the panel, which needs to react the horizontal forces due to the wind.

In its simplest embodiment the panel therefore has just two structural elements, namely the thin plank (2a, 2b) and the rack (3).

It is the rack (3) which transmits and spreads the forces between the panel and the primary bearing system and therefore allows said panel to operate in sheet mode given that there is no point at which stresses are concentrated.

FIGS. 4 and 5 which illustrate the use of this type of panel in a primary structure in the form of a wooden lattice making it possible with equal ease to produce covering or facade elements, the panel then being mounted between the posts.

Such a panel can be used either as it is, or could take a covering layer, of the metal sheet or some other type, with sealing. In such a case, it is necessary to have several centimeters' thickness of wood for attaching this covering. In this case, to increase the thickness of material involved a square batten (9) is associated with the panel as shown in FIG. 1 and housed under the crest of the panel to anchor long screws that may be as much as 8 to 10 centimeters long.

Such a batten (9) may, for example, be positioned every 3 or 4 crests, depending on the requirements and minimum distances for fastening down the finishing covering layer.

As a facade element, the panel according to the invention can remain as it is, that is to say with the crests facing outward. In this case, the eaves of the roof need to extend out far enough to protect the planks from direct rainwater.

For roofing, the panel can also be used as it is. In this case, the negative crests are placed in the direction of the slope to allow water to run off. In this type of application, the various planks (2a, 2b) are sealed at the bottom (10) and top (11) crests so that there is no leak or ingress of water through the roofing complex (see FIG. 3).

In general, such a panel can therefore be used just as easily for roofing as for facades, as it can in the form of a slab.

Use for Roofing

For roofing, the panel can be mounted between two bearing structure trusses in the longitudinal direction (see FIGS. 4 and 5). The two racks (3) of the ends of the panels (1) are then locked against the trusses and stabilize these in respect of horizontal forces. The racks could possibly be placed on the trusses.

In any event, they transmit and spread the loads without concentrating them at any point.

In the case of its use for roofing, said panel may act as a secondary structure, as ceiling, and as the cladding for the underside of the roof. In roofing, an OSB (Oriented Strand Board) 8 to 13 millimeters thick may be laid to take a sealed roof cover of the elastomer or equivalent type, for example polyurethane resin.

In this design as roofing panels, the panel according to the invention has very good acoustics and an esthetic appearance of the wooden ceiling type. The quality of the finish may be enhanced by planing the planks.

This panel may possibly be insulated so as to provide a complex with effective thermal insulation performance against hot and against cold. In this case, a semirigid sheet of insulation is placed on the top waves before a sealed covering is added. The insulation could possibly be injected if the panel according to the invention is associated with a covering panel thus forming a box section. The insulation is then an expanding synthetic foam or any other material such as cork, rockwool, glass wool or recycled paper. The insulation could possibly consist of wood chips mixed with sawdust.

When laid in the direction of the pitch, the panel is therefore borne by the racks (3) which rest on the trusses. A sheet metal covering or covering of the elastomer type, sealed as before, may be laid as an external finishing layer. However, the panel may itself act as the covering. For that, the bottoms of the waves are sealed with seals (10) and the tops of the waves are sealed with a cap (11), for example made of plastic, covering the screwed region (see FIG. 3). When the panels are used as they are, the planks may be tanalized in an autoclave with metal salts of the copper-chromium boron or copper-chromium arsenate type for better wood durability.

The joints between two panels, laid longitudinally or in the direction of the pitch, are produced by screwing the last plank to the upper level as is apparent from FIG. 1.

In certain cases, a packer may be used to compensate for a dimensional variation or a difference with respect to the last panel laid.

Use as a Facade

The panels according to the invention can be laid as a facade, on the outside of the truss posts, with the rack (3) between the posts or on the posts. This panel can therefore stabilize the facade in the face of horizontal forces (wind). The number of screws is then determined so as to react the horizontal forces in shear.

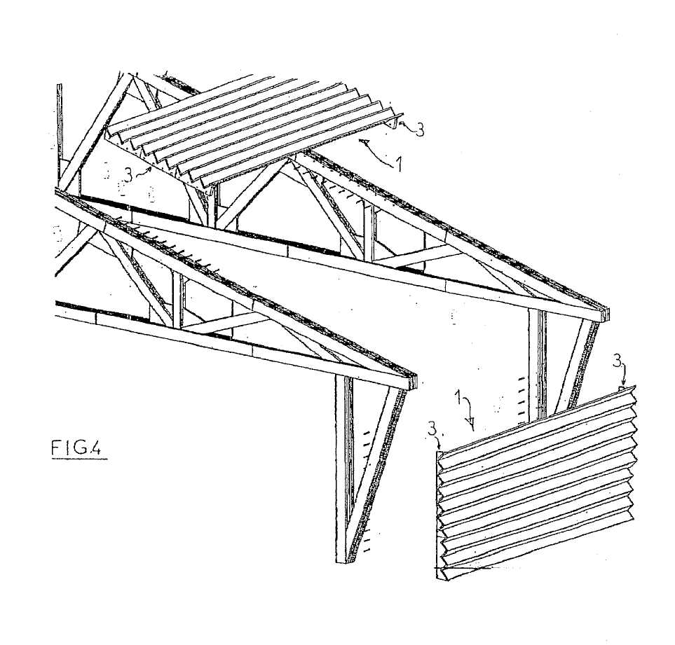

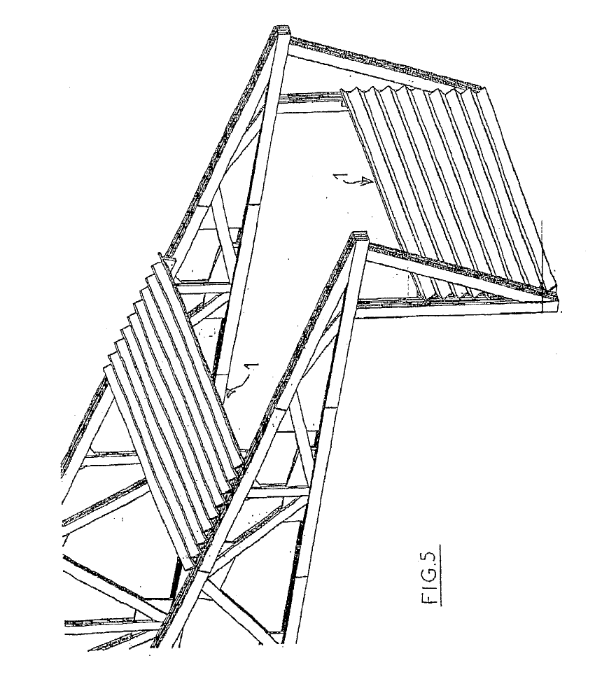

As before, the panels can remain as they are and act as walls or can be associated with insulating materials (20) and with an internal or external panel (21) as illustrated in FIGS. 6 and 7.

Such panels can be laid just as easily horizontally (FIG. 6) as vertically (FIG. 7). In the former instance, the arrival of rainwater needs to be reduced by having eaves protecting said panels. In the latter instance, they may be partially exposed to the rain provided that the sealing beads in the bottoms of the ribs are correctly affixed.

Furthermore, in order to improve the architecture of the panels, some may incorporate planks made of a translucent material of the Plexiglas or cellular plastic type thus allowing light to enter and provide natural illumination to the inside of the building.

With panels laid horizontally, horizontal strips of light will therefore be obtained and with panels laid vertically, vertical strips of light will be obtained.

It is also possible to juggle a mixture of vertical panels and horizontal panels to accentuate the effect of facades.

Use as a Floor Slab

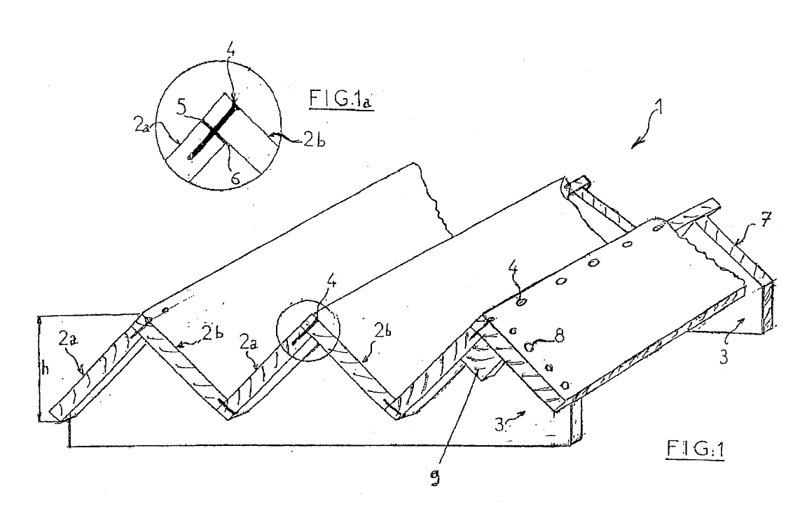

The panel according to the invention is able to support heavy loads if the planks are wider. In this case, these planks are made, for example, from glue-laminated structures or laminated veneer lumber making it possible to achieve very large sizes, as depicted in FIG. 2.

The bearing capacity of the panel allows it to be used as floor slabs in dwellings, industrial or commercial buildings, or even as bridge decks.

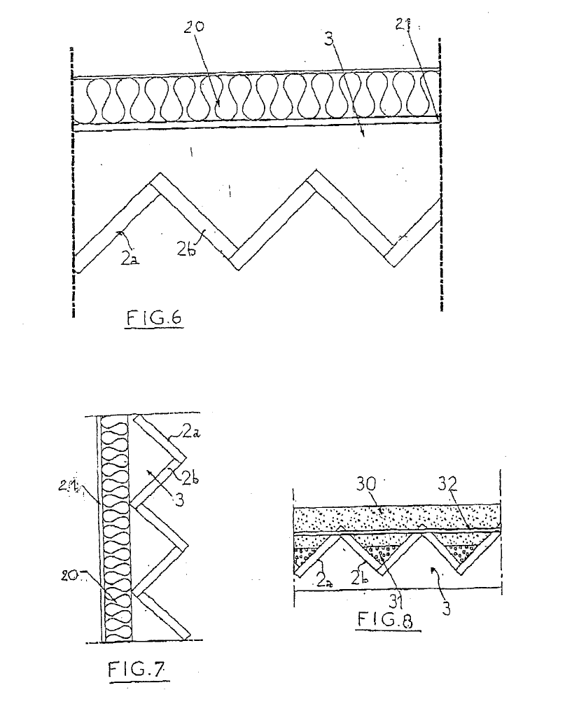

It is possible to enhance the effectiveness of the panel according to the invention by combining it with a layer of concrete (30) in the compression region, as illustrated in FIG. 8. In addition, a filling layer (31), based on sand, paper or some other equivalent material, may be placed in the corner formed between the planks (2a-2b) under the layer of concrete (30).

To improve the effectiveness of the two materials joined together and which make up its final section, metal rods (32) can be added to work in shear and block the relative movement of the concrete with respect to the wood.

Of course, the invention is not restricted to the foregoing examples but covers all alternative forms thereof produced in the same spirit.

1. A self-supporting wooden building panel that can be used just as easily for producing walls as it can for floors, ceilings or coverings, comprising a succession of planks (2a, 2b) of rectangular cross section, joined together to form a V structure, characterized in that:
the planks (2a, 2b) are mounted on two parallel racks (3) and are fixed by screws (4) to the crests of said racks which constitute rigid elements perpendicular to the axis of the planks (2a, 2b);
two consecutive planks (2a, 2b) are joined together by screwing the edge (6) of one plank (2a) against the end of the flat (5) of the consecutive plank (2b);
the two racks (3) perpendicular to the axis of the planks form a template for positioning them, preferably at 90° with respect to one another.

2. The building panel as claimed in claim 1, characterized in that the planks are made of solid wood, reconstituted wood or glue-laminated wood.

3. The building panel as claimed in one of claims 1 and 2, characterized in that some of the planks of which it is made are made of a translucent material of the Plexiglas or cellular plastic type.

4. The panel as claimed in one of claims 1 to 3, characterized in that the planks (2a, 2b) make an angle of between 80 and 1000 between them.

5. The building panel as claimed in one of claims 1 to 4, characterized in that it is associated with an insulating layer (20) or with an external or internal panel (21).

6. The panel as claimed in one of claims 1 to 4, characterized in that it is associated with a layer of concrete (30) arranged in the compression zone, a filling layer (31) based on sand, paper or some other equivalent material being arranged in the corner formed between the planks (2a, 2b) under the layer of concrete (30).
